(19) United States
(12) Patent Application Publication
(10) Pub. No.: US 2013/0117021 A1
(43) Pub. Date: May 9, 2013

(54) MESSAGE AND VEHICLE INTERFACE INTEGRATION SYSTEM AND METHOD

(71) Applicant: GM Global Technology Operations LLC, Detroit, MI (US)

(72) Inventor: Frances H James, Sunnyvale, CA (US)

(73) Assignee: GM Global Technolog Operations LLC, Detroit, MI (US)

(21) Appl. No.: 13/664,481

(22) Filed: Oct. 31, 2012

Related U.S. Application Data
(60) Provisional application No. 61/555,209, filed on Nov. 3, 2011.

(51) Int. Cl. B60Q 1/00; G10L 13/08; G10L 15/26

(52) U.S. Cl. 704/235; 340/425.5; 704/260; 704/E15.043; 704/E13.001

(57) ABSTRACT

A method and system uses an integration application to extract an information feature from a message and to provide the information feature to a vehicle interface device which acts on the information feature to provide a service. The extracted information feature may be automatically acted upon, or may be outputted for review, editing, and/or selection before being acted on. The vehicle interface device may include a navigation system, infotainment system, telephone, and/or a head unit. The message may be received by the vehicle interface device or from a portable or remote device in linked communication with the vehicle interface device. The message may be a voice-based or text-based message. The service may include placing a call, sending a message, or providing navigation instructions using the information feature. An off-board or back-end service provider in communication with the integration application may extract and/or transcribe the information feature and/or provide a service.

### CROSS-REFERENCE TO RELATED APPLICATIONS

This application claims the benefit of U.S. Provisional Patent Application No. 61/555,209 filed on Nov. 3, 2011, which is hereby incorporated by reference in its entirety.

### TECHNICAL FIELD

The present invention relates generally to message integration with an onboard vehicle system.

### BACKGROUND

An increasing number of vehicles are being configured such that portable consumer electronic devices, for example, smart phones, may interface with the human machine interface (HMI) offered by the vehicle. The vehicle and portable device interface may be configured for hands-free use, which may, for example, reduce user distraction by allowing users to carry on conversations without physically holding the mobile phone. Hands-free use may include hands-free call initiation and answering, which may be voice activated by the user.

A user of a portable device may receive messages, such as voicemail and/or text-based messages directed to the user's portable device while the user is in a vehicle which is being operated. Listening to voicemail or reviewing a text-based message differs from having a phone conversation with a live person, in that the voice or text message can frequently contain information that the user may need to note or record for further action. The information may include, for example, contact information such as a telephone number or a network address, such as an e-mail address, or a location which may be in the form of an address, building name, business name, intersection, etc. Acting on such information may include inputting the information into a system or device, such as a phone or PDA to place a call or send a text-based message, inputting the information into a navigation system to obtain directions to a destination, or providing the information to a vehicle integrated service provider, such as the OnStar® service system, for further action by the service provider. Such information may require immediate action, such as immediately returning a call, or inputting location information of the current destination of the vehicle into the navigation system, where it may be desirable to complete such action without interrupting or delaying operation of the vehicle, for example, by stopping the vehicle to retrieve and/or record the message information from the voicemail or text message, and/or to input the message information into a device or system for action.

Speech recognition systems are available to transcribe voicemails into a text format. Some of these systems may be able to identify phone numbers or addresses within the transcription text, however not in a format which is of immediate use by the user in a hands-free way. If, for example, the user wants to enter the address provided in the voicemail or text message into the vehicle navigation system, the user must enter the address either by hand or use a speech input system while referring back to the voicemail transcription/message text while inputting the information, to verify the correct address, which may result in distraction of the user while the vehicle is in operation.

### SUMMARY

A method and system provided herein uses an integration application to extract an information feature from a message received by a portable device of a user, and to provide the information feature to a vehicle interface device. The vehicle interface device acts on the information feature to provide a service. The extracted information feature may be automatically acted upon by the vehicle interface device, or may be outputted for review, editing, and/or selection prior to being acted on. The vehicle interface device may include a navigation system, infotainment system, telephone, and/or a head unit. The portable device may be a smart phone or other computing device capable of receiving the message. The message may be a voice-based or text-based message. The service may include placing a call or providing navigation instructions using the information feature. An off-board or back-end service provider in communication with the integration application may extract and/or transcribe the information feature and/or provide a service. The off-board or back end service provider may be a vehicle integrated service provider, such as the OnStar® service system. The information feature is extracted from the message and provided to the vehicle interface device, and the service corresponding to the information feature may be completed in a generally hands-free manner, thereby minimizing distraction of the user while the vehicle is in operation.

In one example, the method includes linking a portable device and a vehicle interface device, wherein one of the portable device and the vehicle interface device includes an integration application, and receiving a voice-based or text-based message containing at least one information feature on the portable device. By way of non-limiting example, the information feature may be a location indicator, such as an address, intersection, landmark, business name, building name, etc., may be a telephone number, or may be a network address, such as an e-mail address, a Twitter® username, or Skype® name. The method further includes extracting the information feature from the message, and may include selecting the information feature using a user interface in communication with the integration application. The integration application may be configured to output the information feature to a user interface defined by one of the portable device and the vehicle device interface, where the information feature may be reviewed, edited and/or selected for use to provide a service. The user interface may be configured to visually display and/or audibly output the information feature, and may include a touch-screen or audio command mechanism to enable selection and/or editing of the information feature. The information feature may be provided to the vehicle interface device, and acted on by the vehicle interface device to provide the service, which may include placing a call or sending a message, for example, to a telephone number corresponding to the information feature, or providing navigation instructions to a location corresponding to the information feature.

The method may include converting a voice-based information feature to a text-based information feature. This text-based feature may be presented in the user interface visually, or may be converted back to audio using text-to-speech (TTS) and presented audibly through the user interface. The purpose of presenting the information feature, either visually or audibly, is to allow the user to verify its equivalence to the original information feature in the voicemail.

The system includes a portable device configured to receive a message containing an information feature and a vehicle interface device configured to provide a service using the information feature, wherein the portable device and the vehicle interface device are configured to selectively link with each other. An integration application in communication with at least one of the portable device and the vehicle interface device may be configured to extract the information feature from the message for use by the vehicle interface device in providing the service.

The system may further include an off-board server configured to selectively communicate with at least one of the portable device and the vehicle interface device in communication with the integration application to receive the message, extract the information feature from the message, and provide the extracted information feature to the integration application. In one example, the off-board server is configured to transcribe the information feature into a text-based information feature. In another example, the information feature may be sent to the off-board server by one of the portable device and the vehicle interface device to provide a service.

The above features and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic view of a message and vehicle interface integration system;

FIG. 2 is a flowchart of a method for providing an information feature of a message received by a portable device to a vehicle interface device using the integration system of FIG. 1; and

FIG. 3 is a schematic view of another example of a message and vehicle interface integration system.

### DETAILED DESCRIPTION

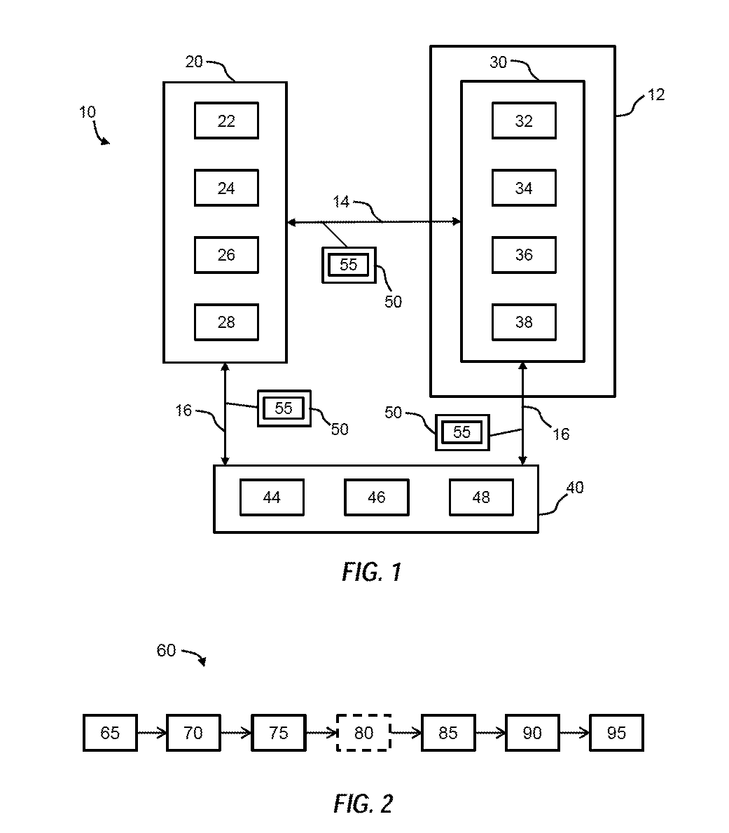

Referring to the drawings wherein like reference numbers represent like components throughout the several figures, there is shown in FIG. 1 a schematic view of a message to vehicle interface integration system 10 including a portable device 20 configured to be in selective communication with a vehicle interface device 30 through, for example, a communications link 14. The vehicle interface device 30 is located on-board or is included in a vehicle 12.

The portable device 20 may be carried by a user of the interface system 10 and the vehicle 12. An example of a portable device 20 includes, but is not limited to, a smart phone, a netbook, a personal digital assistant (PDA), and any other computing device capable of receiving a message 50. The message may include an information feature 55, which may be, for example, a telephone number or location indicator. The portable device 20 may include a user interface 22, which may also be referred to as a human-machine interface (HMI), configured to output a message 50 including the information feature 55. The user interface 22 may include audio input and output, a keypad, touchscreen, and a display, such that the message 50 may be output by displaying the message on the touchscreen display, for example, when the message 50 is configured in a text-based format, or by audibly playing back the message 50, for example, when the message 50 is configured in a voice-based format. The user interface 22 may include a touchscreen which may be utilized by a user to make selections by voice command, by touching an application/icon or other feature on the screen or utilizing a cursor or other selector mechanism to navigate to the application/icon. The user interface 22 may include an audio input which may be utilized by a user to make selections by using voice commands or other audible signals. The user interface 22 may be configured such that the user may use a combination of touch and voice commands to interact with the portable device 20.

The portable device 20 may include an operating system 24 which may provide functionality such as authenticating the portable device 20 to the interface device 30 through a handshaking process or other authenticating process, presenting a menu or listing to a user through the user interface 22, and enabling one or more applications 26. The operating system 24 and/or portable device 20 may include memory which is configured of sufficient size and type to store data and other information and to store and/or execute a plurality of applications 26. The plurality of applications 26 may include, for example, phone, voicemail, text messaging, email, navigation, a web browser. As described herein, the plurality of applications 26 may also include one or more of an integration application, a transcription application and an extraction application, or a combination of these. For example, the integration application may be configured to extract and/or transcribe an information feature 55 from a message 50. The portable device 20 further includes a communications interface 28 which may be used to enable interaction between the portable device 20 and the vehicle interface device 30, which may include sending and receiving data and information including a message 50 and/or an information feature 55 through the communications link 14.

The communication link 14 may be a wireless communication medium, for example, Bluetooth, Wi-Fi, etc., or may be a wired communication medium, for example, a universal serial bus (USB) or other hardwire cable. A protocol may be used over the communication link 14 to project graphics from the portable device 20 and the vehicle interface device 30. The portable device 20 may also utilize a direct hardware video out signal to project the contents of the user interface 22 of the portable device 20 onto a user interface 32 included in the vehicle interface device 30, which may be, for example, a touchscreen included in the user interface 22.

The communications interface 28 of the portable device 20 may be configured to selectively communicate with other devices which may include telephones, portable devices, and one or more off-board (e.g., off vehicle) servers or systems 40, which may be selectively linked with the portable device 20 through a communications link 16 which may be a wireless communication link in communication with a telecommunications network or the internet.

An example of an off-board system 40 may include a service provider, which may be configured as a server located off-board the vehicle 12, e.g., at a location remote from the vehicle 12. The off-board server 40 may be a vehicle integrated service provider, such as the OnStar® service system, which may be selectively linked to the vehicle interface device 30 and/or in communication with the portable device 20. The server 40 may include an operating system 44 which may provide functionality such as authenticating a device in communication with the server 40, which may be, for example, the portable device 20 or the interface device 30, through a handshaking process or other authenticating process, and enabling one or more applications 46. The operating system 44 and/or server 40 may include memory which is configured of sufficient size and type to store data and information and store and execute the plurality of applications 46. The plurality of applications 46 may include, for example, phone, voicemail, text messaging, email, navigation, web browser, message analysis including information feature extraction, message transcription including voice-to-text transcription using, for example, automatic speech recognition (ASR), and text-to-speech (TTS) conversion. The server 40 further includes a communications interface 48 which may be used to enable interaction between the portable device 20 and/or the vehicle interface device 30, which may include sending and receiving data and information including a message 50 and/or an information feature 55 through the communications link 14, or providing other services, such as navigation instructions, telephone, text, email and/or other messaging services.

One or more servers 40 may be selectively linked to at least one of the portable device 20 and the vehicle interface device 30. For example, a first server 40 may be selectively linked to the vehicle interface device 30, where the first server 40 is configured as a service provider or back-end server to process information features 55 and provide services related thereto to the vehicle 12. In one example, the first server 40 may be configured as a back-end such as the OnStar® system. A second server 40 may be selectively linked to one of the portable device 20 and the vehicle interface device 30 and configured to receive a message 50 from one of the portable device 20, the vehicle interface device 30, and the integration application, and to extract the information feature(s) 55 from the message 50 and/or transcribe or convert the message 50 and/or information feature(s) 55.

The vehicle 12 includes the vehicle interface device 30, which may be configured to include or be included in a head unit, an infotainment system, a navigation system, and/or an on-board telephone system of the vehicle 12. The vehicle interface device 30 may include a user interface 32, which may also be referred to as a human-machine interface (HMI), configured to output a message 50 including the information feature 55. The user interface 32 may include audio input and output, physical controls located within the vehicle (e.g., on the steering wheel or positioned in the center console), a touchscreen, and a display, such that the message 50 may be output by displaying the message on the touchscreen, for example, when the message 50 is configured in a text-based format, or by audibly playing back the message, for example, when the message 50 is configured in a voice-based format. The user interface 32 may include a touchscreen which may be utilized by a user to make selections by voice command, by touching an application/icon or other feature on the screen or utilizing a cursor or other selector mechanism to select an application/icon or other feature displayed on the touch screen. The user interface 32 may include an audio input which may be utilized by a user to make selections by using voice commands or other audible signals. The user interface 32 may be configured such that the user may use a combination of touch and voice commands to interact with the vehicle interface device 30.

The vehicle interface device 30 may include an operating system 34 which may provide functionality such as authenticating the portable device 20 to the vehicle interface device 30 through a handshaking process or other authenticating process, presenting a menu or listing to a user through the user interface 32, and enabling one or more applications 36. The operating system 34 and/or vehicle interface device 30 may include memory which is configured of sufficient size and type to store and execute a plurality of applications 36. The plurality of applications 36 may include, for example, phone, voicemail, text messaging, email, navigation and a web browser. As described herein, the plurality of applications 36 may also include one or more of an integration application, an extraction application, a transcription application or a combination of these. The vehicle interface device 30 further includes a communications interface 38 which may be used to enable interaction between the portable device 20 and the vehicle interface device 30, which may include sending and receiving data and information including a message 50 and/or an information feature 55 through the communications link 14.

The communications interface 28 of the vehicle interface device 30 may be configured to selectively communicate with other devices which may include telephones, portable devices, servers or systems which may be selectively linked with the vehicle interface device 30 through a communications link 16 which may be a wireless communication link in communication with a telecommunications network or the internet.

It would be understood that the elements of the vehicle interface device 30 including but not limited to the user interface 32, the operating system 34, the plurality of applications 36, the communications interface 38 and memory for operating the vehicle interface device 30 may be distributed within the vehicle 12 to define, in combination, the vehicle interface device 30.

An integration application configured to integrate an information feature 55 of a message 50 received by the portable device 20 with the vehicle interface device 30 may reside on one of the portable device 20 and the vehicle interface device 30, such that the integration application may be selectively in communication with both the portable device 20 and the vehicle interface device 30 when the portable device 20 and the vehicle interface device 30 are linked, for example, through the communications link 14. The integration application may be included as one of the plurality of applications 26, 36.

In an illustrative example, the integration application may be configured to access a message 50 received by the portable device 20, to extract an information feature 55 from the message 50, for use in providing a service to the user. The message 50 may be received as a voice-based message, such as a voice mail message, including a voice-based information feature 55. The message 50 may also be received as a text-based message, such as a short message service (SMS) message, a text message, an e-mail, a network message, such as a tweet, or other text-based message including a text-based information feature 55. The information feature 55 may be a feature which is actionable by one of the portable device 20 and the vehicle interface device 30. For example, the information feature 55 may be a telephone number, wherein the service provided by one of the portable device 20 and/or the vehicle interface device 30 includes one of placing a telephone call to the telephone number, and/or sending a message to the telephone number, which may be a voicemail, text message, SMS, etc. In another example, the information feature 55 may be a network address, wherein the service provided by one of the portable device 20 and/or the vehicle interface device 30 may include sending a message, which may be a text message, SMS, e-mail, tweet, etc., or placing a call to the network address, using, for example, a voice over internet protocol (VoIP) service such as Skype®. As another example, the information feature 55 may be a location indicator such as an address, which may be a street address or other form of address such as an intersection, a building name, a business name, a landmark, etc. The location indicator may be of any form, for example, which may be inputted into a navigation system to obtain location information such as directions and/or navigation instructions corresponding to the location indicator. A telephone number may also be used as a location indicator, for example, when the telephone number corresponds to a location, address, business, building, etc. for which navigation information is requested.

The integration application may be configured to extract the information feature 55 from the message 50, or may be in communication with a system or application configured to extract the information feature 55 from the message 50. The extraction system or application may be remotely located from the integration application and accessible by or linked to the integration application such that the message 50 may be sent to the extraction system or application and the extracted information feature 55 may be received from the remote extraction system or application by the integration application. In one example, the integration application may be one of the applications 26 resident on the portable device 20 or one of the applications 36 resident on the vehicle interface device 30, and the extraction application may be one of the applications 36 resident on the vehicle interface device 30 or one of the applications 46 resident on the off-board server 40, which may be in linked communication with the integration application through the portable device 20 or vehicle interface device 30 such that the integration application and the extraction application may be in communication to send and receive the message 50 and/or the information feature 55. The extracted information feature 50 may be provided to a service provider, for example, an application 36 on the vehicle device 30, in the as received format, or in a transcribed format. The service provider acting on the information feature 55 may be one of the portable device 20, the vehicle interface device 30, and the server 40, or two or more of these may act in combination to provide a service using the information feature 55.

For example, where the message 50 is a text-based message, such as an SMS, an e-mail, a tweet, or other network or internet-related message, the extracted information feature 55 may be a text-based information feature. In another example, where the message 50 is a voice-based message, such as a voice mail, the extracted information feature 50 may be in voice-based format which may be outputted by audibly playing back the voice-based information feature 50, or may be transcribed into a text-based information feature 55 and outputted through a display as text. The text-based information feature 55 may be transcribed from text into a voice-based information feature 55 using, for example, a text-to-speech (TTS) technique, such that the transcribed voice-based information feature 55 may be outputted by audibly playing back the voice-based information feature 55 through one of the user interface 22 of the portable device 20 or the user interface 32 of the vehicle interface device 30.

The integration application may be configured to modify or transcribe the information feature 55 or may be in communication with a transcription system or application configured to modify or transcribe the information feature 55. In one example, automatic speech recognition (ASR) may be used to transcribe a voice-based message 50 and/or information feature 55 to a text-based message 50 and/or information feature 55. In another example, text-to-speech (TTS) may be used to convert a text-based message 50 and/or information feature 55 to a voice-based, e.g., audible, message 50 and/or information feature 55. The transcription system or application may be remotely located from the integration application, and accessible by the integration application such that the message 50 and/or information feature 55 may be sent to the transcription system or application and the transcribed form of the message 50 and/or information feature 55 may be received from the remote transcription system or application by the integration application. In one example, the integration application may be one of the applications 26 resident on the portable device 20 or one of the applications 36 resident on the vehicle interface device 30, and the transcription application may be one of the applications 36 resident on the vehicle interface device 30 or one of the applications 46 resident on the off-board server 40, which may be in linked communication with the integration application through the portable device 20 or vehicle interface device 30 such that the integration application and the transcription application may be in communication to send and receive the message 50 and/or the information feature 55.

The integration application may be configured to send the information feature 55 to one or more of the applications 26, 36, 46 such that a service using the information feature 55 can be provided. FIG. 2 shows, in non-limiting example, a method 60 which may be used to integrate an information feature 55 extracted from a message 50 received by the portable device 30 with the vehicle interface device 30 to provide a service. Referring now to the method 60 shown in FIG. 2, a step 65 may include linking a portable device 20 and a vehicle interface device 30, as shown in FIG. 1, and accessing an integration application, where one of the portable device 20 and the vehicle interface device 30 includes the integration application. The integration application, as previously described, may be one of the plurality of applications 26, 36, such that when the portable device 20 and the vehicle interface device 30 are linked, the integration application may be accessible by and/or in communication with the portable device 20 and the vehicle interface device 30.

At step 70, a message 50 received by the portable device 20 may be accessed for review. The message 50 may be automatically accessed and/or selected by the integration application, or may be accessed and/or selected by a user, for example, from a list of messages outputted to the user through one of a user interface. The user interface may be one of the user interface 22 of the portable device 20 or the user interface 32 of the vehicle interface device 30. The list of messages may be audibly output, e.g., played back to the user through one of the linked devices 20, 30, or visually displayed, for example, on a screen or touchscreen of one of the user interfaces 22, 32, and may be selected from the list by audible or other hands-free command, by touching the selected message on the screen, by pressing a button, or otherwise. The selected message may be outputted through at least one of the user interfaces 22, 32 for review by a user. Where the message 50 is received as a voice-based message, the message 50 may be audibly played back to the user, or transcribed and displayed as a text-based message 50 to the user. Where the message 50 is received as a text-based message, the message 50 may be visually displayed as a text-based message or may be audibly played back to the user, for example, using a text-to-speech conversion of the message 50.

The message 50 may contain an information feature 55 which is immediately relevant to the user, e.g, useable as an input to a service required by the user while the user is in the vehicle. For example, the information feature 55 may be a telephone number, and the service required may be contacting the telephone number to place a call, send a message, etc. In another example, the information feature 55 may be a network address, such as an e-mail address, a Twitter® username, or Skype name, and the service required may be using the network address to send a message, place a call, etc. In another example, the information feature 55 may be a location indicator such as an address representing the destination to which the user is travelling in the vehicle 12, and the service required may be navigation instructions to reach the destination.

At step 75, the information feature 55 is extracted from the message 50, and is outputted using at least one or a combination of the user interfaces 22, 32. Extracting the information feature 55 from the message 50 at step 70 may include, as described previously, sending the message 50 to an application 26, 36, 46, wherein extracting the information feature 55 may include transcribing or modifying the information feature 55 from an as received format, such as a voice-based format, to a format suitable for inputting into the system 10 to provide a service based on the information feature 55, which may be a text-based format. In one example, the information feature 55 may be transcribed to a text-based information feature 55 for input to the message integration system 10, which may include processing by the integration application, input into a telephone application, input into a navigation system, and/or input into a messaging service. Extracting the information at step 75 may also include saving and/or storing the information feature 55, for example, in a memory of the portable device 20 and/or the vehicle interface device 30, such that the information feature 55 may be retrievable for reference or use.

Continuing with step 75, the information feature 55 is outputted using at least one of the user interfaces 22, 32. For example, the outputted information feature 55 may be audibly played back using the user interface 32 of the vehicle 12, and may be visually displayed in text format on one or both of the user interfaces 22, 32. The message 50 may contain more than one information feature 55, wherein at the step 75, the plurality of information features 55 may be outputted to the user for review and/or selection of an information feature 55 to be acted upon by the vehicle interface device 30 and/or integration application to provide a service. For example, the message 50 may include a telephone number and a building name. The user may select the building name as an information feature 55 to be acted upon, to obtain navigation instruction from a navigation system. The navigation system may be one of the applications 36 included in the vehicle 12, or the navigation instruction may be provided by an off-board service provider 40, which may be, for example, a service provider such as the OnStar® system. The navigation instruction may be output through a visual display and/or as an audible (verbal) instruction through one or a combination of the user interfaces 22, 32. The user may select the telephone number as another information feature 55 to be acted upon, to place a telephone call to the telephone number. The telephone call may be placed using the portable device 20 in linked communication with the vehicle interface device 30, for example, to complete the phone call in a hands-free manner.

At step 80, the system 10 may be optionally configured for review and editing of the information feature 55. By way of non-limiting example, the information feature 55 may be received as a part of a telephone number, such as the local number without an area code, or in the case of an international number, without the country code. At step 80, the telephone number may be outputted (played back or displayed) as received, and the user may edit the number to add the missing area or country code, such that the edited number may be inputted into a telephone, which may be the portable device 20 or a telephone integrated into the vehicle interface device 30, to place the call. In another example, the information feature 55 may be received as a voice-based feature, such as an address spoken in a voice mail message. The voice-based address may be extracted and transcribed to a text-based address, then the text-based transcribed address may be transcribed to a text-to-speech (TTS) voice-based address and may be audibly played back to the user, for comparison with the as received voice-based address, for verification and/or review for accuracy, e.g., to ensure the TTS address, voice-based (as received) address, and the text-based address are equivalent. The user may edit the address to correct any inaccuracies in transcription and/or to provide supplementary information, such as an intersecting street, a city, a building name, etc. The user may edit the information feature 55 in a hands-free manner, for example, by using voice commands, or by providing input through a touch screen, or otherwise providing input through at least one of the user interfaces 22, 32.

At step 85, the information feature 55 to be acted upon is selected. The information feature 55 may be selected by an audible or other hands-free command, by pressing a button, by touching the selected message on the screen, or otherwise, to be acted upon to provide a service. The system 10 and/or integration application may be configured such that the information feature 55 is automatically selected for action. The information feature 55 may be selected from a list of information features 55 which may audibly output, e.g., played back to the user through one of the linked devices 20, 30, or visually displayed, for example, on a screen or touchscreen of one of the user interfaces 22, 32, by a manual command, which may be an audible or other hands-free command, by touching the selected information feature 55 on the screen, or otherwise. More than one information feature 55 may be acted upon sequentially or concurrently. For example, a first information feature 55 such as an address may be provided to the navigation system in the vehicle 12 to provide directions to the location corresponding to the address, while the portable device 20 initiates a telephone call to a second information feature 55 which is extracted as a telephone number.

At step 90, the selected information feature 55 is provided to the appropriate system, device and/or application for action thereon at step 95 to provide a service. By way of example, the information feature 55 may be provided to the vehicle interface device 30 to be acted on by a navigation system which may be included in the vehicle interface device 30 or in the vehicle 12 in communication with the vehicle interface device 30. In another example, the selected information feature 55 may be a telephone number provided at step 90 to the portable device 20, or to a telephone included in the vehicle 12 and/or vehicle interface device 30. The device 20, 30 may place a call or send a message to the telephone number represented by the information feature 55 at step 95, wherein the service of placing a call may include using the vehicle interface device 30 to conduct the call in a hands-free manner. In another example, the selected information feature 55 may be a location indicator which is provided at step 90 to a navigation system. The navigation system may be one of the applications 26 on the portable device 20 or the applications 36 the vehicle interface device 30, such that at step 95, the navigation system may act on the address information feature 55 to provide instructions that may be outputted, for example, through the vehicle user interface 32 and/or the user interface 22, or a combination of these, where the output may be provided to the user in a hands-free format. The address information feature 55 may be provided to the off-board service provider 40, where the address may be acted upon to provide navigation instructions, e.g., directions, to the user through the user interface 32, where the vehicle interface device 30 is in linked communications with the off-board service provider 40.

Referring again to FIGS. 1 and 2, in an example configuration using touch-based interaction with the message integration system 10, at step 65 the portable device 20 and the vehicle interface device 30 are paired through the communications link 14, for example, using MirrorLink™, such that the touch interaction with the portable device 20 may occur through a touchscreen included in the user interface 32 of the vehicle interface device 30. Alternatively and/or concurrently, touch interaction with the system 10 may occur through a touch screen included in the user interface 22 of the portable device 20. The integration application in the present example is run natively in one of the vehicle 12 or the portable device 20, such that the integration application is in communication with the devices 20, 30. At step 70, the user launches an application, which may be the integration application or one of the applications 26, 36, to access voicemail, such that, for example, a listing of available voicemail messages 50 is displayed on the user interfaces 20, 30. The user selects a voice mail from the listing for audible playback to the user. The selected voice mail message 50 may be played back to the user using one of the user interfaces 20, 30 or a combination thereof.

At step 75, the voice mail message 50 is transcribed by the integration application or another application 26, 36, 46 in communication with the integration application, and the text-based transcription of the voice mail message 50 is displayed on one or both of the user interfaces 20, 30. The information features 55 are extracted from the voice mail message 50 and may be highlighted, underscored, or otherwise identified within the transcribed message 50 and/or in a separate listing displayed to the user. At step 85, the user may select an information feature 55 from the message or listing to be provided to the vehicle interface device 30 and/or an application 36 on the vehicle 12 at step 90. At step 95, the information feature 55 is acted upon to provide a service to the user, as described previously herein.

In another example, voice-based interaction with the message integration system 10 may be used to reduce user distraction or diversion during use of the system 10, since voice only interaction does not require visual or touch interaction. In this example, at step 65 the portable device 20 and the vehicle interface device 30 are paired through the communications link 14, such that an integration application residing on one of the devices 20, 30 is in communication with the linked devices 20, 30. At step 70, the user uses a voice command to access a voice mail message 50 which has been received by the portable device 20, and listens to an audible playback of the voice mail message 50. At step 75, the integration application extracts one or more information features 55 from the message 50, and transcribes the information feature 55 from the as received voice-based format to a text-based information feature 55. The integration application then converts the text-based information feature 55 to a TTS information feature 55, which is audibly played back to the user through a user interface 20, 30 of the system 10. By playing back the TTS information feature 55, the user has the opportunity at step 80 to compare the TTS information feature and the as received voice-based information feature to verify the information feature 55 was correctly and accurately transcribed from the as received voice-based message 50. At step 85, the user may select, using a voice command, the information feature 55 to be provided to a service provider at step 90.

In one example, the user may command the portable device 20, through the user interface 32 and the communication link 14, which may be a Bluetooth™ hands-free connection, to place a call to a telephone number represented by the information feature 55. In another example, the user may provide a voice command to the integration application to use the vehicle interface device 30, which may include an integrated phone, to place the call. As another example, the information feature 50, e.g., the telephone number, and other information, such as an identifier of the vehicle 12 or vehicle interface device 30, may be provided to the off-board service provider 40 using the integration application and/or the vehicle interface device 30, through the communication link 16. The off-board service provider 40 may use a call control mechanism to contact the vehicle 12, for example, by dialing out to an integrated vehicle phone in the vehicle 12, and by dialing out to the telephone number corresponding to the information feature 55, then connecting the two to establish the telephone call between the user and the party corresponding to the telephone number 55.

The examples provided herein are not intended to be limiting. For example, multimodal interaction with the message integration system 10 and/or integration application is possible, which may occur using a hybrid or combination of voice-based and touch-based interactions with one or both of the user interfaces 22, 32. The message 50 may be displayed in a text-based format on a touchable screen for touch interaction through at least one of the user interfaces 22, 32 while simultaneously playing back a TTS listing of the extracted information features 55, providing the user the option of selecting an information feature 55 from the touch screen by touch, or by using a voice command.

In another example, the information feature 55 may be a location indicator such as an address extracted from a text-based transcription of a voice mail message 50 and selected by the user for navigation instruction. An application programming interface (API), which may be one of the plurality of applications 26 residing in the portable device 20, can be used to send the address to the vehicle interface device 30, or to an off-board service provider 40. By way of example, the API may be an OnStar® API and the off-board service provider 40 may include an OnStar Remote Link to the vehicle 12 and/or the vehicle interface device 30, or may include linking to Google™ Maps or a similar internet service configured to communicate with the vehicle 12 to provide navigation instructions. Navigation instructions can be provided as a service to the user through the off-board service provider 40 by downloading the instructions corresponding to the address information feature 55 to the navigation system in the vehicle 12, or in another example, audibly providing the instructions to the user through the user interface 32 of the vehicle 12 using the off-board service provider 40 in communication with the vehicle 12. An example of the latter may be the OnStar® Turn-by-Turn service.

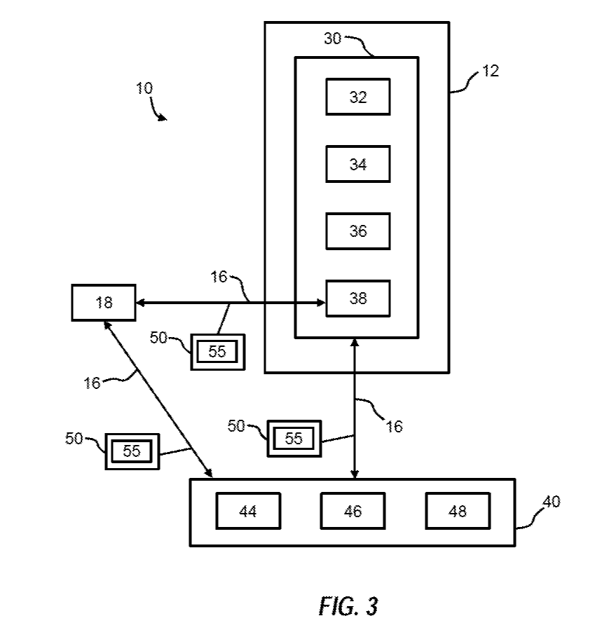

FIG. 3 shows another example configuration of the message integration system 10. As shown in FIG. 3, the message 50 may be received by a communication interface 38 from an off-board source 18, for example, through a communications link 16 established with the communication interface 38. The off-board source 18 may be a telephone, a navigation system, a global positioning system (GPS) or other device configured to selectively link to the communication interface 38 to provide a message 50. As described previously, the message 50 may be one of a voice-based or text-based message including one or more information features 55. In one example, the communication interface 38 may include a telephone, a smartphone, a personal digital assistant (PDA), a navigation system, a GPS, or other computing device configured to receive the message 50 from the off-board source 18. The communication interface 38 may receive the message 50 from a back-end server or off-board service provider 40, which may be selectively linked to the vehicle interface device 30 through a communication link 16, as previously described. In one example, the back-end server 40 may be a service provider system such as the OnStar® system. In one example, the off-board source 18 may communicate with the off-board service provider 40 to provide a message 50 to the off-board service provider 40, where the message 50 and/or the information feature 55 is subsequently provided to the vehicle interface device 30 and the integration application by the off-board service provider 40.

In the example shown in FIG. 3, the integration application may reside on the vehicle 12, e.g., the integration application may be one of the applications 36, and may retrieve the message 50 from the communication interface 38 for processing as previously described herein, including extracting one or more information features 55 from the message 50 for use in providing a service using the vehicle interface device 30. The integration application may reside on the back-end server 40, e.g., the integration application may be one of the applications 46, and may extract one or more information features 55 from a message 50 received by one of the back-end server 40 and the vehicle interface device 30. The message 50 may be transcribed from voice to text, and/or converted from text to TTS, by the integration application, or an application 36, 46, or may be sent to another off-board server 40 configured for that purpose. As described previously, the message 50 including at least one information feature 55 may be received as a voice-based or text-based message, and may be, for example, a telephone number, a location indicator, or other relevant information feature which may be used to provide a service using the vehicle interface device 30.

Other configurations of the system and method described herein are possible, and the examples provided herein are not intended to be limiting. The information feature extraction methods as described herein may be applied, for example, to other forms of incoming messages, including network messages such as e-mails, instant messages, tweets, blog postings, etc. The information feature may be configured in any form of relevant information which may be useable as an input to provide a service, which may include, for example, an account number, passcode, or other alpha-numeric string which may be recognizable for extraction as an input to a service provider. The service provided may include messaging services such as sending a voice mail, text message, SMS, e-mail or other network message to a destination, which may be a phone number, an e-mail address or other network address, or other identifier of the intended recipient.

While the best modes for carrying out the invention have been described in detail, those familiar with the art to which this invention relates will recognize various alternative designs and embodiments for practicing the invention within the scope of the appended claims.

1. A method comprising:
receiving a message containing an information feature on a vehicle interface device;
extracting the information feature from the message using an integration application in communication with the vehicle interface; and
providing the information feature to the vehicle interface device.

2. The method of claim 1, further comprising:
providing a service related to the information feature using the vehicle interface device.

3. The method of claim 2, wherein providing the service further includes:
linking the vehicle interface device with an off-board server;
providing the information feature to the off-board server; and
providing the service using the off-board server in communication with the vehicle interface device.

4. The method of claim 2, wherein:
the information feature is configured as one of a telephone number, a network address, and a location indicator; and
the service includes one of placing a telephone call, sending a network message, and providing a navigation instruction corresponding to the information feature.

5. The method of claim 1, wherein the vehicle interface device includes a user interface, the method further comprising:
outputting the information feature to the user interface.

6. The method of claim 1, wherein extracting the information feature includes:
providing the information feature to an off-board server in communication with the integration application; and
using the off-board server to extract the information feature from the message.

7. The method of claim 1, wherein the message is a voice-based message.

8. The method of claim 7, further comprising:
transcribing the information feature from voice to text, such that the information feature is provided to the vehicle interface device as a text-based feature.

9. The method of claim 8, further comprising:
converting the text-based feature to a text-to-speech (TTS) feature; and
audibly outputting the TTS feature using the user interface.

10. The method of claim 1, wherein the message contains at least one other information feature; the method further comprising:
extracting the at least one other information feature from the message;
selecting one of the information feature and the at least one other information feature; and
providing the selected one of the information feature and the at least one other information feature to the vehicle interface device.

11. The method of claim 1, wherein receiving a message containing the information feature on the vehicle interface device further comprises:
receiving the message from one of an off-board server and a portable device;
link the one of the off-board server and the portable device with the vehicle interface device; and
sending the message to the vehicle interface device using the one of the off-board server and the portable device.

12. A system comprising:
a vehicle interface device configured to:
receive a message containing an information feature; and
provide a service using the information feature; and
an integration application in communication with the vehicle interface device and configured to extract the information feature from the message for use by the vehicle interface device in providing the service.

13. The system of claim 12, further comprising:
an off-board server configured to selectively communicate with the vehicle interface device and the integration application;
wherein the off-board server is further configured to at least one of:
receive the message and provide at least one of the message and the information feature to the vehicle interface device;
extract the information feature from the message and provide the extracted information feature to the integration application; and
provide the service.

14. The system of claim 12, wherein the vehicle interface device is configured to:
selectively link with a portable device; and
to receive the message containing the information feature from the portable device.

15. The system of claim 12, wherein:
the message as received is configured as a voice-based message including a voice-based information feature; and
the integration application is configured to convert the voice-based information feature to a text-based information feature.

16. The system of claim 12, wherein:
the message as received is configured as a text-based message including a text-based information feature; and
the integration application is configured to convert the text-based information feature to a text-to-speech (TTS) information feature.

17. The system of claim 12, wherein the integration application is configured to output the information feature to a user interface defined by one of the vehicle device interface and a portable device in communication with the integration application.

18. The system of claim 12, wherein:
the user interface is configured to audibly output the information feature; and
the information feature which is audibly output is one of a voice-based information feature extracted from the message, and a text-to-speech (TTS) information feature converted from a text-based transcription of the voice-based information feature.

19. A method comprising:
linking a vehicle interface device with a portable interface device, wherein one of the vehicle interface device and the portable device includes an integration application;
receiving a message containing an information feature on the portable device;
extracting the information feature from the message using the integration application;
outputting the information feature to a user interface in communication with at least one of the portable device and the vehicle interface device; and
providing a service related to the information feature using the vehicle interface device.

20. The method of claim 19, further comprising at least one of:
transcribing the information feature from voice to text, such that the information feature is provided to the vehicle interface device as a text-based feature;
converting the text-based feature to a text-to-speech (TTS) feature;
audibly outputting the TTS feature using the user interface; and
verifying the TTS feature and the information feature are equivalent.
